(19) United States
(12) Patent Application Publication
(10) Pub. No.: US 2005/0162530 A1
(43) Pub. Date: Jul. 28, 2005

(54) Correlated double sampling circuit, signal processing circuit, and solid-state imaging apparatus

(75) Inventor: Takeo Matsui, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC ELECTRONICS CORPORATION

(21) Appl. No.: 11/038,441

(22) Filed: Jan. 21, 2005

(30) Foreign Application Priority Data
Jan. 22, 2004 (JP) 2004-013789

(51) Int. Cl. H04N 5/228; H03K 5/00

(52) U.S. Cl. 348/222.1

(57) ABSTRACT

The correlated double sampling circuit includes a plurality of sampling circuits. Each of the sampling circuits samples each of a plurality of color signals which are sequentially output from a solid-state imaging device.

### BACKGROUND OF THE INVENTION

1. Field of the Invention

The present invention relates to correlated double sampling circuits, signal processing circuits, and solid-state imaging apparatus. Particularly, the invention relates to the correlated double sampling circuit, signal processing circuit, and solid-state imaging apparatus which process a signal from a color solid-state imaging device.

2. Description of Related Art

Recent solid-state imaging apparatus such as a digital camera include a solid-state imaging device with high pixel density. The solid-state imaging device is a charge coupled device (CCD), for example. Further, higher speed devices with lower power consumption are needed. The low power consumption and high speed operation are conflicting goals since higher speed generally requires higher power consumption.

In a solid-state imaging device, a plurality of photo-detectors composed of photodiode and so on photoelectrically convert light into a signal charge and store the signals. Then, a charge integration amplifier converts the signal charge into a voltage signal. In this process, reset noise occurs in the reset operation after converting a signal charge of one pixel into a voltage. To remove the reset noise, solid-state imaging apparatus have a correlated double sampling (hereinafter abbreviated as CDS) circuit.

The configuration and operation of a conventional CDS circuit is explained hereinafter with reference to FIGS. 10 to 13. FIG. 10 is an example of a circuit diagram of a conventional CDS circuit. The CDS circuit 102 samples the signal clamped to the voltage of a voltage source as a reference voltage and outputs the sampled signal to a variable gain amplifier 103. The variable gain amplifier 103 amplifies the output signal from the CDS circuit 102 to a given level and outputs it to an A/D converter, a video signal processor and so on in the next stage.

The CDS circuit 102 includes a capacitor C101, a clamping circuit CL101, a buffer amplifier BA101 and a sampling circuit SH101. The capacitor C101 receives an output signal from an imaging device 101. The clamping circuit CL101 clamps the output signal to a reference voltage. The buffer amplifier BA101 amplifies the clamped signal. The sampling circuit SH101 samples the amplified signal and outputs it from the CDS circuit 102.

The clamping circuit CL101 includes a voltage source V101 and a clamping switch SW101. The voltage source V101 generates a reference voltage during clamping, with one end grounded. The clamping switch SW101 connects the voltage source V101 to the capacitor C101 and the input end of the buffer amplifier BA101 during clamping.

The sampling circuit SH101 includes a capacitor C102 and a sampling switch SW102. The capacitor C102 samples and holds the output signal from the buffer amplifier BA101, with one end grounded. The sampling switch SW102 connects the capacitor C102 to the output end of the buffer amplifier BA101 and the input end of the variable gain amplifier 103.

The clamping switch SW101 and the sampling switch SW102 are turned on or off according to pulse signals P101 and P102, respectively, which are applied from a control logic 104.

FIG. 11 shows an example of a timing chart of a conventional CDS circuit. The imaging device 101 outputs an initial voltage after reset of a stored charge in a reference period, and outputs a photoelectrically converted color signal in a color signal period. The reference period and the color signal period are repeated in each pixel. In this example, the pulse signal P101 is applied in the reference period, and the pulse signal P102 is applied in the color signal period.

Upon receiving the pulse signal P101, the clamp circuit CL101 clamps the output signal from the imaging device 101 in the reference period to a reference voltage. The clamped signal is input to the sampling circuit SH101 via the buffer amplifier BA101. Upon receiving the pulse signal P102, the sampling circuit SH101 samples the output signal from the buffer amplifier BA101 in the color signal period. The sampled signal is input to the variable gain amplifier 103.

In this way, the CDS circuit 102 clamps the output signal from the imaging device 101 in the reference period and samples the clamped signal in the color signal period, thereby removing reset noise contained in the output signal of the imaging device 101.

FIG. 12 shows another example of a conventional CDS circuit. In FIG. 12, the same reference symbols as in FIG. 10 designate the same elements. The CDS circuit 102 clamps a signal not to the voltage of a voltage source but to the voltage of an output signal from the imaging device 101 in the reference period.

The CDS circuit 102 includes a capacitor C101, a DC regeneration circuit DC101, a buffer amplifier BA101, a sampling circuit SH101, a sampling circuit SH102, and a sampling circuit SH103. The capacitor C101 receives the output signal from the imaging device 101. The DC regeneration circuit DC101 regenerates a direct-current component. The buffer amplifier BA101 amplifies the DC-regenerated signal. The sampling circuit SH101 samples the signal in the color signal period. The sampling circuit SH102 samples the signal in the reference period. The sampling circuit SH103 matches the phases of the sampling signals in the reference period.

The DC regeneration circuit DC101 includes a voltage source V101 and a resistor R101. The voltage source V101 generates a given voltage, with one end grounded. The resistor R101 connects the voltage source V101 to the capacitor C101 and the input end of the buffer amplifier BA101.

Like the sampling circuit SH101, the sampling circuits SH102 and SH103 respectively include the capacitor C103 and C104 and the sampling switch SW101′ and SW103.

The sampling switches SW101′, SW102 and SW103 are turned on or off according to pulse signals P101, P102 and P103, respectively, which are applied from the control logic 104.

The CDS circuit 102 operates in accordance with the same timing chart as shown in FIG. 11. The pulse signal P103 is input in the same timing as the pulse signal P102 so that the phases of the output signals from the sampling circuits SH101 and SH103 match.

The pulse signal P101 is input to the sampling circuit SH102 in the reference period. The sampling circuit SH102 thereby samples a reference voltage of the output signal from the imaging device 101 and outputs the sampled signal to the sampling circuit SH103. Then, the pulse signal P102 is input to the sampling circuit SH101 in the color signal period. The sampling circuit SH101 thereby samples the output signal from the buffer amplifier BA101, and outputs the sampled signal to the variable gain amplifier 103. Further, the pulse signal P103 is input to the sampling circuit SH103 in the color signal period. The sampling circuit SH103 thereby outputs a signal having the phase which matches the phase of the output signal from the sampling circuit SH101 to the variable gain amplifier 103. In this example, the variable gain amplifier 103 clamps the sampling signal in the color signal period to the voltage of the sampling signal in the reference period as a reference voltage, and outputs the clamped signal to the next stage.

In this way, the CDS circuit 102 samples the output signal from the imaging device 101 both in the reference period and in the color signal period, and clamps the sampling signal in the color signal period to the voltage of the sampling signal in the reference period, thereby removing reset noise in the imaging device 101.

The imaging device 101 in FIGS. 10 and 12 may have a color filter in a reticular pattern called Bayer pattern. Each pixel has a color filter which transmits one of red (R), green (G), blue (B) or other colors. The imaging device 101 sequentially outputs time-series color signals per each pixel or color filter.

Generally, a change in the color in one pixel of an imaging object is relatively small, and the spatial frequency is low. However, even if the spatial frequency is low, since the output signals from the imaging device 101 are sequentially outputted per each color filter, the frequency of the output signal can be high depending on the color and characteristic of adjacent color filters. This increases a difference in the signal level of the color signals outputted per each pixel.

For example, in the case where a filter which transmits red and a filter which transmits green are alternatively arranged and the imaging device outputs color signals in the same order as the color filter arrangement, if an imaging object is red, the output from the imaging device is large in the color filter which transmits red and small in the other part. The imaging device thereby outputs a large signal and a small signal one after another, thus outputting the signal with high frequency.

With the high frequency of the output signal from the imaging device, which is a large difference in adjacent color signals, the voltage applied to the capacitor for each sampling increases in the sampling circuit of the CDS circuit. This results in an increase in a load to the buffer amplifier in the previous stage of the sampling circuit, which increases power consumption. Further, a drive capacity across a large bandwidth range is required for the buffer amplifier. Furthermore, a circuit which samples a high-frequency signal requires high power, which hinders the achievement of low power consumption.

Japanese Unexamined Patent Application Publication No. 04-275793 discloses a signal processing circuit which samples the output signal from an imaging device by dividing the signal into each color signals.

As described above, the present invention has recognized that conventional CDS circuits have the problem that increase in a difference in color signals output from an imaging device causes higher power consumption.

### SUMMARY OF THE INVENTION

According to one aspect of the invention, there is provided a correlated double sampling circuit, including a plurality of sampling circuits, each of which samples each of a plurality of color signals sequentially output from a solid-state imaging device. This allows reduction of a difference in the voltage of the color signal sampled by each sampling circuit. A load to an amplifier and so on which supplies a voltage to each sampling circuit thereby decreases, thus achieving lower power consumption.

According to another aspect of the invention, there is provided a signal processing circuit including an amplifier which amplifies a first color signal and a second color signal sequentially output from a solid-state imaging device, a first sampling circuit which samples the amplified first color signal, a second sampling circuit which samples the amplified second color signal, a first timing regulator which adjusts an output timing of the signal sampled by the first sampling circuit, and a second timing regulator which adjusts an output timing of the signal sampled by the second sampling circuit. This allows reduction of a difference in the voltage of the color signal sampled by each sampling circuit. A load to an amplifier and so on which supplies a voltage to each sampling circuit thereby decreases, thus achieving lower power consumption.

According to still another aspect of the invention, there is provided a solid-state imaging apparatus including a solid-state imaging device which sequentially outputs a plurality of color signals, a first sampling circuit which samples a first color signal selected from the plurality of color signals, a second sampling circuit which samples a second color signal selected from the plurality of color signals, a first switching circuit which outputs the signal sampled by the first sampling circuit, a second switching circuit which outputs the signal sampled by the second sampling circuit, and an amplifier which amplifies the signal output from the first switching circuit or the second switching circuit. This allows reduction of a difference in the voltage of the color signal sampled by each sampling circuit. A load to an amplifier and so on which supplies a voltage to each sampling circuit thereby decreases, thus achieving lower power consumption.

The present invention allows reduction of power consumption even if a difference in color signals output from an imaging device is large.

### BRIEF DESCRIPTION OF THE DRAWINGS

The above and other objects, advantages and features of the present invention will be more apparent from the following description taken in conjunction with the accompanying drawings, in which:

FIG. 1 is a block diagram of a solid-state imaging apparatus of the invention;

FIG. 2 is a plan view of a color filter array used in an imaging device of the invention;

FIG. 3 is a circuit diagram of a CDS circuit of the invention;

FIG. 4 is a circuit diagram of a buffer amplifier of the invention;

FIG. 5 is a circuit diagram of a variable gain amplifier of the invention;

FIG. 6 is a timing chart of a CDS circuit of the invention;

FIG. 7 is a timing chart of a CDS circuit of the invention;

FIG. 8 is a circuit diagram of a CDS circuit of the invention;

FIG. 9 is a circuit diagram of a CDS circuit of the invention;

FIG. 10 is a circuit diagram of a conventional CDS circuit;

FIG. 11 is a timing chart of a conventional CDS circuit; and

FIG. 12 is a circuit diagram of a conventional CDS circuit.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

### First Embodiment

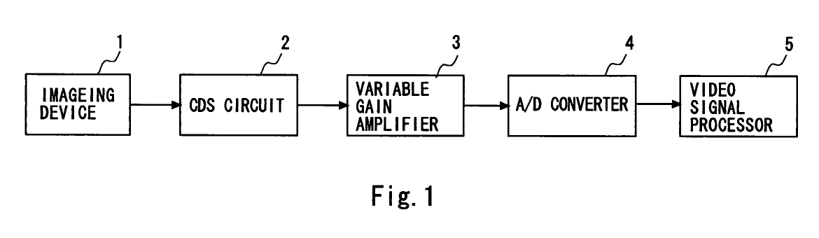

Referring first to FIG. 1, the structure of a solid-state imaging apparatus according to a first embodiment of the invention is explained. The solid-state imaging apparatus includes an imaging device 1, a CDS circuit 2, a variable gain amplifier 3, an A/D converter 4, and a video signal processor 5. These components may be integrated in one chip or may be formed in a given number of chips. For example, the CDS circuit 2, the variable gain amplifier 3 and the A/D converter 4 may be integrated in one chip. Further, all the components may be included in one solid-state imaging apparatus, or, if the video signal processor 5 is configured by a personal computer (PC), it maybe configured as a separate apparatus from the solid-state imaging apparatus.

For example, the imaging device 1 photoelectrically converts light into a signal, and outputs the generated signal to the CDS circuit 2. The CDS circuit 2 removes the noise contained in the output signal. Then, the variable gain amplifier 3 amplifies the signal with no noise to a given level. After that, the A/D converter 4 converts the amplified signal into a digital signal. Finally, the video signal processor 5 creates a video signal.

The imaging device 1 is a color solid-state imaging device which photoelectrically converts incident light into an electric signal. For example, the imaging device 1 may be a CCD or CMOS image sensor. Further, the imaging device 1 may be either an area sensor or a line sensor. The imaging device 1 may include a color filter, a photo-detector such as photodiode, a charge transfer device, a charge integration amplifier, and so on, for example.

One method for taking a color image is to combine a color filter array, which is detailed later, with the imaging device 1 to separate a color signal corresponding to each color filter from the output of the imaging device 1. For example, when taking a color image, the light incident on the imaging device 1 is split into different colors by the color filter and transmitted to a photo-detector. The light is photoelectrically converted into a signal charge in the photo-detector. The signal charge is then input as each color signal to the CDS circuit 2 via a charge transfer device and a charge integration amplifier.

The CDS circuit 2 removes the noise contained in the output signal from the imaging device 1 according to a reference voltage. It samples each color signal and outputs the sampled signal to the variable gain amplifier 3. The CDS circuit 2 is detailed later.

The variable gain amplifier 3 amplifies the output signal from the CDS circuit 2 to an optimal level. For example, if the output signal from the CDS circuit 2 is −6 dB to 10 dB, the variable gain amplifier 3 may amplify the signal to 0 to 30 dB. Since the signal level is different for each color signal, the variable gain amplifier 3 may perform color correction such as white balance on each color signal.

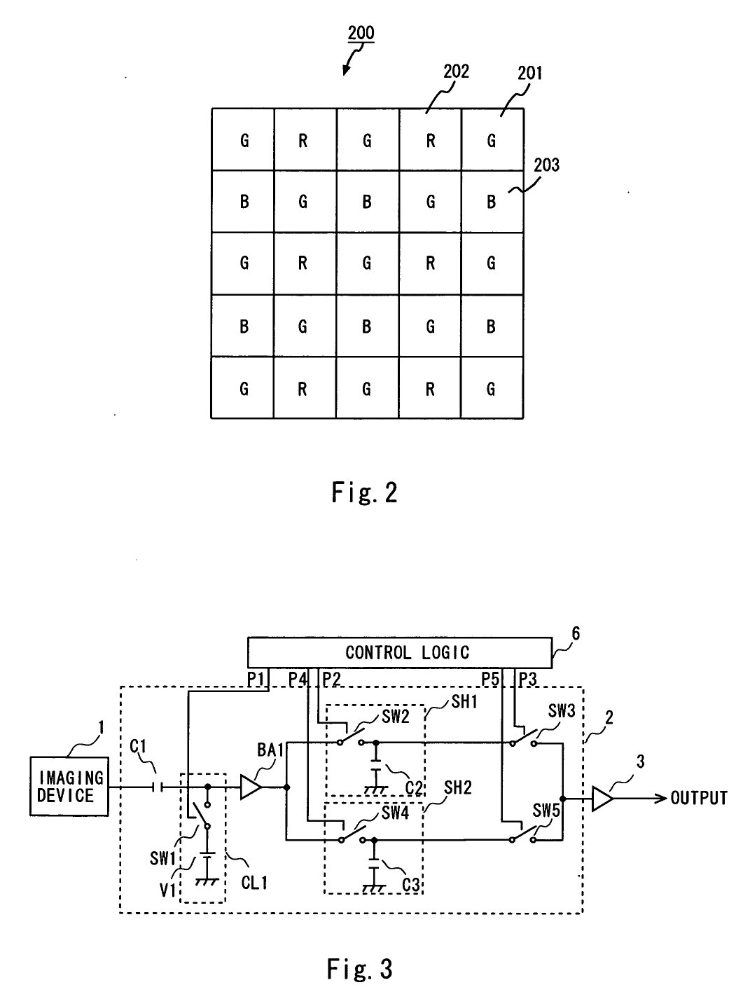

FIG. 2 is a plan view which schematically shows an example of a color filter array used in the imaging device of this embodiment. The color filter array 200 includes a green (G) filters 201, red (R) filters 202, and blue (B) filters 203 arranged in a given repetitive pattern both in the horizontal direction and the vertical direction. The color filter array 200 has a Bayer pattern in which a certain line (a horizontal line, which is also called a scan line) includes a series of G, R, G, R color filters, and the next line includes a series of B, G, B, G color filters. In this pattern, the G filters 201 are arranged at 180° phase difference in each line, and the R filters 202 and the B filters 203 exists alternately in adjacent lines. The imaging device 1 has a photo-detector for each color filter and outputs the color signals generated in the photo-detector per each line. Thus, the G color signal and the R color signal are alternatively output in one line, and the B color signal and the G color signal are alternatively output in the next line.

The colors passing through each color filter are not limited to the above example, but may be other colors. For example, cyanogen, magenta, yellow, and so on may be used. Further, the pattern of the color filters is also not limited to the above example, but maybe another pattern. For example, a stripe pattern may be used.

Referring then to FIG. 3, the configuration of the CDS circuit of this embodiment is explained below. The CDS circuit 2 includes a capacitor C1, a clamping circuit CL1, a buffer amplifier BA1, a sampling circuits SH1 (first sampling circuit), a sampling circuit SH2 (second sampling circuit), an output switch SW3 (first timing regulator), and an output switch SW5 (second timing regulator). The capacitor C1 receives the output signal from the imaging device 1. The clamping circuit CL1 clamps the output signal to a reference voltage. The buffer amplifier BA1 amplifies the clamped signal. The sampling circuits SH1 and SH2 sample the amplified signal. The output switches SW3 and SW5 control the output timing of the signals sampled by the sampling circuits SH1 and SH2, respectively. All of these components may be integrated in one chip, or the capacitor C1 may be configured as a separate device from the chip.

The clamping circuit CL1 includes a voltage source V1 and a clamping switch SW1. The voltage source V1 generates a reference voltage during clamping, with one end grounded. The clamping switch SW1 is turned on during clamping.

The sampling circuits SH1 and SH2 are connected to the buffer amplifier BA1. The sampling circuit SH1 includes a capacitor C2 and a sampling switch SW2. The capacitor C2 samples and holds the output signal from the buffer amplifier BA1. The sampling switch SW2 is turned on during sampling. Similarly, the sampling circuit SH2 includes a capacitor C3 and a sampling switch SW4. The configurations of the sampling circuits SH1 and SH2 are not limited to this example, and the sampling circuit of another configuration may be used.

The clamping switch SW1, the sampling switch SW2, the output switch SW3, the sampling switch SW4, and the output switch SW5 are turned on or off according to pulse signals P1 to P5, respectively, which are applied from a control logic 6.

One end of the capacitor C1 is connected to the output end of the imaging device 1. The other end of the capacitor C1 is connected to the clamping switch SW1 and the input end of the buffer amplifier BA1. The output signal from the imaging device 1 is input to the clamping switch SW1 via the capacitor C1.

One end of the clamping switch SW1 is connected to the capacitor C1 and the input end of the buffer amplifier BA1, and the other end is connected to a voltage source V1. The clamping switch SW1 is turned on or off according to the pulse signal P1. For example, the clamping switch SW1 is turned on during clamping to connect the voltage source V1, the capacitor C1 and the input end of the buffer amplifier BA1, and turned off when the clamping is finished to disconnect the connection. During the clamping, the clamping switch SW1 clamps the output signal of the imaging device 1 from the capacitor C1 to a reference voltage of the voltage source V1. The clamped signal is then input to the sampling circuits SH1 and SH2 via the buffer amplifier BA1.

One end of the sampling switch SW2 is connected to the output end of the buffer amplifier BA1, and the other end is connected to the capacitor C2 and the output switch SW3. The sampling switch SW2 is turned on or off according to the pulse signal P2. For example, the sampling switch SW2 is turned on when sampling to connect the output end of the buffer amplifier BA1, the capacitor C2, and the output switch SW3, and turned off when the sampling is finished to disconnect the connection.

One end of the capacitor C2 is connected to the sampling switch SW2 and the output switch SW3, and the other end is grounded. When sampling, the capacitor C2 is connected to the output end of the buffer amplifier BA1 via the sampling switch SW2 to sample and hold the signal amplified by the buffer amplifier BA1. When outputting the sampling signal, the capacitor C2 is connected to the input end of the variable gain amplifier 3 via the output switch SW3 so that the sampled and held voltage is input as a sampling signal to the variable gain amplifier 3.

One end of the output switch SW3 is connected to the sampling switch SW2 and the capacitor C2, and the other end is connected to the input end of the variable gain amplifier 3. The output switch SW3 is turned on or off according to the pulse signal P3. For example, the output switch SW3 is turned on when outputting the sampling signal to connect the sampling switch SW2, the capacitor C2, and the input end of the variable gain amplifier 3, and turned off when the output is finished to disconnect the connection.

The sampling switch SW4, the capacitor C3, and the output switch SW5 are connected in parallel with the sampling switch SW2, the capacitor C2, and the output switch SW3, each operating in the same manner. The other ends of the output switches SW3 and SW5 are connected to each other, and the connection node is connected to the input end of the variable gain amplifier 3.

In this embodiment, the sampling circuits SH1 and SH2 sample a different color signal. In the case of using the color filter array shown in FIG. 2, the output signal from the imaging device alternatively contains two colors of signals; thus, each of the two colors is sampled by each of the sampling circuits SH1 and SH2.

For example, if the output signal from the imaging device 1 in a certain line contains G and R color signals, the sampling circuit SH1 samples the G color signal and the sampling circuit SH2 samples the R color signal. If the output signal in the next line contains B and G color signals, the sampling circuit SH1 samples the G color signal and the sampling circuit SH2 samples the B color signal. Since the G color signal is contained in the signal of every line in this example, the G color signal may be sampled by the same sampling circuit. Alternatively, it may be sampled by a different sampling circuit. After finishing the processing of the signals in one line and when starting the processing of the signals in the next line, the control logic 6 may allocate the color signal to be input to each sampling circuit.

The number of sampling circuits is not limited to this example. More number of sampling circuits may be connected in parallel. For example, the number of sampling circuits may be equal to the number of total colors of color filters, or equal to the number of color signals contained sequentially in one line of output signal.

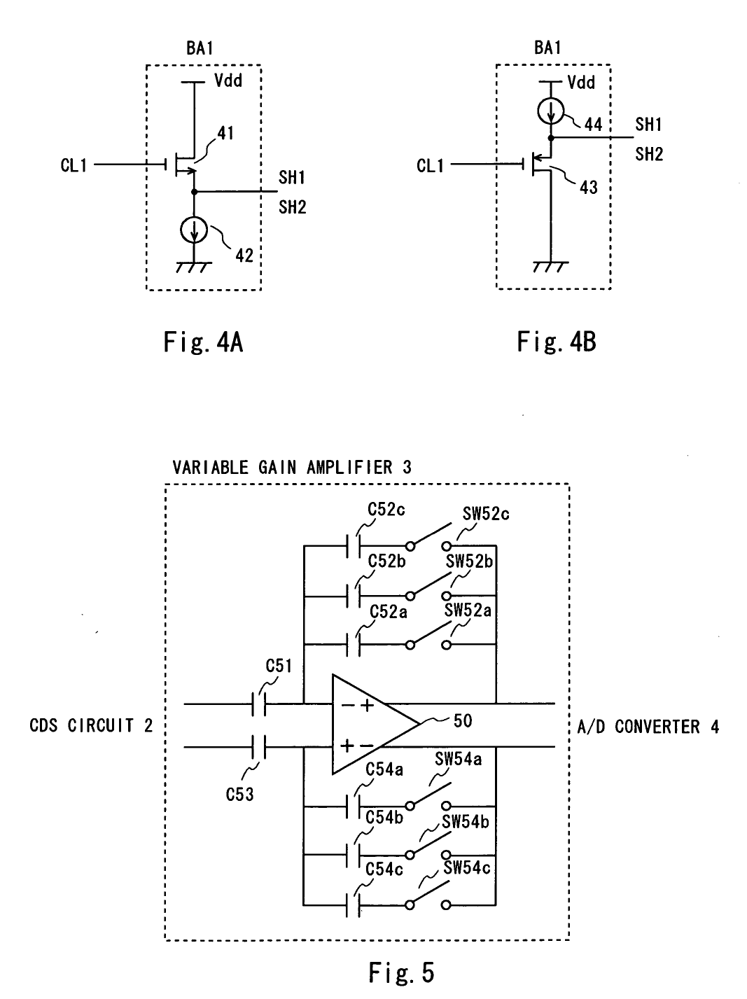

FIGS. 4A and 4B show examples of the buffer amplifier BA1 of this embodiment. The buffer amplifier BA1 is a voltage buffer, and it may be a source follower using a Metal Oxide Semiconductor Field Effect Transistor (MOSFET). FIG. 4A shows the case of using an N-channel MOSFET, and FIG. 4B shows the case of using a P-channel MOSFET. The buffer amplifier BA1 may use either the N-channel MOSFET or P-channel MOSFET. Use of the P-channel MOSFET is preferred since it causes less noise. The configuration of the buffer amplifier BA1 is not limited to these examples, and other configurations may be applied.

In the buffer amplifier BA1 of FIG. 4A, the drain of the N-channel MOSFET 41 receives a power supply voltage Vdd, the gate receives the clamped signal from the clamping circuit CL1, and the source is grounded via a constant current source 42. The buffer amplifier BA1 outputs the signal which is amplified in accordance with the clamped signal from its source to the sampling circuits SH1 and SH2.

In the buffer amplifier BA1 of FIG. 4B, the drain of the P-channel MOSFET 43 is grounded, the gate receives the clamped signal from the clamp circuit CL1, and the source receives a power supply voltage Vdd via a constant current source 44. The buffer amplifier BA1 outputs the signal which is amplified in accordance with the clamped signal from its source to the sampling circuits SH1 and SH2.

FIG. 5 is a circuit diagram showing an example of the variable gain amplifier 3 of this embodiment. In the variable gain amplifier 3, the output signal from the CDS circuit 2 is input to an amplifier 50 via capacitors C51 and C53. The signal is amplified in the amplifier 50, and then output from the variable gain amplifier 3 and input to the A/D converter 4. The variable gain amplifier 3 also includes capacitors C52a, C52b, C52c, switches SW52a, SW52b, SW52c, capacitors C54a, C54b, C54c, and switches SW54a, SW54b, SW54c to vary gain.

For example, turning on the switch SW52a connects the input end of the amplifier 50 to the output end of the amplifier 50 via the capacitor C52a, thereby varying the gain of the amplifier 50. The gain in this case is determined by the capacitance ratio of the capacitors C51 and C52a: C51/C52a. Use of the capacitors having different capacitances enables to set a plurality of levels for the gain of the amplifier 50.

The number of capacitors and switches is not limited to this example, but may be arbitrary. The configuration of the variable gain amplifier 3 is not necessarily as shown in FIG. 5, and other configurations may be used.

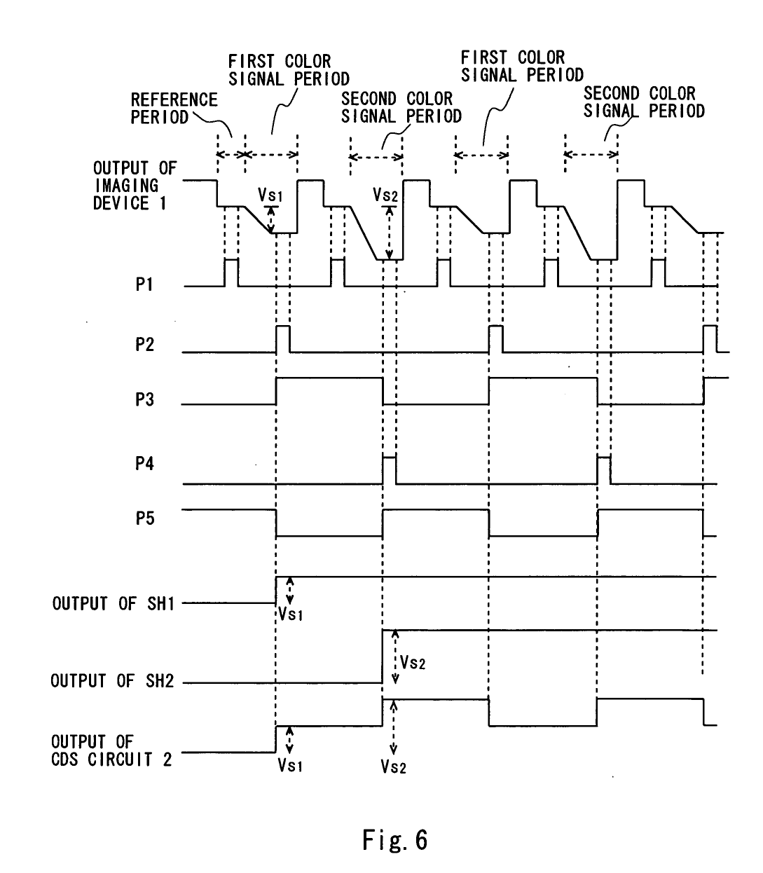

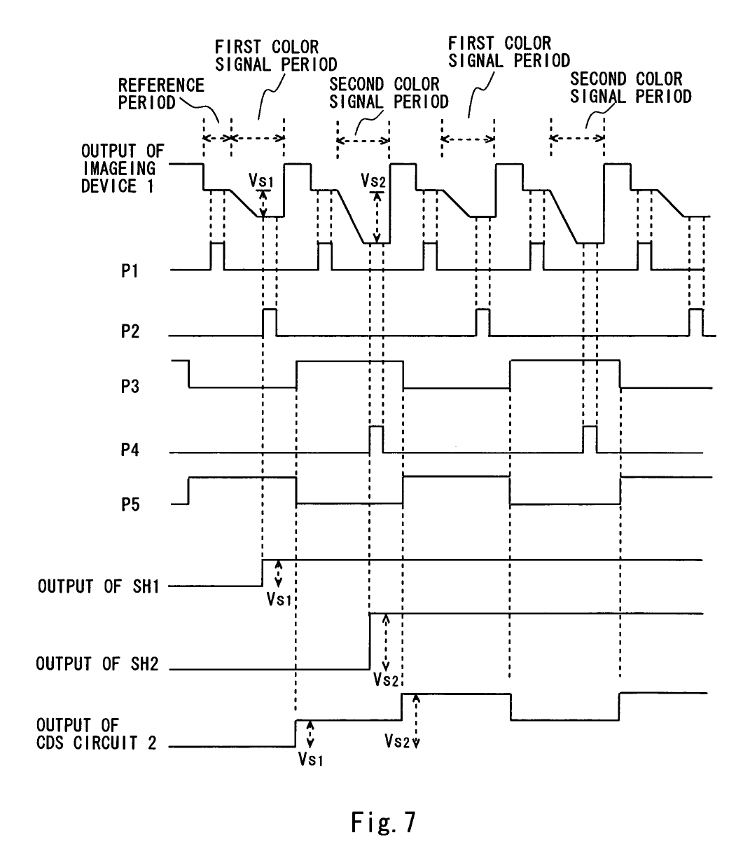

Referring then to the timing charts of FIGS. 6 and 7, the operation of the CDS circuit of this embodiment is explained. FIGS. 6 and 7 show two cases in which the timing of the pulse signals P3 and P5 is different.

In the timing chart of FIG. 6, the imaging device 1 outputs an initial voltage after reset of a stored charge in a reference period, and outputs a photoelectrically converted color signal in a color signal period. The reference period and the color signal period are repeated in each pixel. In the color signal period, color signals of different colors (first and second color signals) are output alternatively as described earlier. For example, the first color signal is a G color signal, and the second color signal is an R color signal.

In this timing chart, the pulse signal P1 is applied in the reference period, the pulse signal P2 is applied in the first color signal period, and the pulse signal P4 is applied in the second color signal period. Further, the pulse signal P3 is applied when the pulse signal P2 is applied and kept until the pulse signal P4 is applied. The pulse signal 5 is applied when the pulse signal P4 is applied and kept until the pulse signal 2 is applied. Equalizing the each periods of the pulse signals P3 and P5 and the pulse signals P2 and P4 allows the order of the color signals in the output signal from the imaging device 1 and the order of the color signals in the output signal from the CDS circuit 2 to be the same.

The pulse signal P1 causes the clamping circuit CL1 to clamp the output signal from the imaging device 1 in the reference period to a reference voltage. The clamped signal is input to the sampling circuits SH1 and SH2 via the buffer amplifier BA1.

The pulse signal P2 causes the sampling circuit SH1 to sample the output signal from the buffer amplifier BA1 in the first color signal period. The sampled signal is input to the output switch SW3. The output signal from the sampling circuit SH1 at this time is Vs1, which is a difference from the reference voltage.

The pulse signal P3 causes the output switch SW3 to output the output signal from the sampling circuit SH1 to the variable gain amplifier 3 from when the sampling circuit SH1 starts sampling to when the sampling circuit SH2 starts sampling. The output from the CDS circuit 2 at this time is Vs1, which is the output from the sampling circuit SH1.

The pulse signal P4 causes the sampling circuit SH2 to sample the output signal from the buffer amplifier BA1 in the second color signal period. The sampled signal is input to the output switch SW5. The output signal from the sampling circuit SH2 at this time is Vs2, which is a difference from the reference voltage.

The pulse signal P5 causes the output switch SW5 to output the output signal from the sampling circuit SH2 to the variable gain amplifier 3 from when the sampling circuit SH2 starts sampling to when the sampling circuit SH1 starts sampling. The output from the CDS circuit 2 at this time is Vs2, which is the output from the sampling circuit SH2.

In the timing chart of FIG. 7, the pulse signals P1, P2, and P4 are applied in the same manner as in the timing chart of FIG. 6. The pulse signal P3 is applied when the pulse signal P2 stops and the sampling circuit SH1 stops sampling and kept until the pulse signal P4 stops and the sampling circuit SH2 stops sampling. The pulse signal P5 is applied when the pulse signal P4 stops and the sampling circuit SH2 stops sampling until the pulse signal P2 stops and the sampling circuit SH1 stops sampling.

Since the timing of the pulse signals P3 and P5 delays compared to their timing in FIG. 6, the output signal of the CDS circuit 2 is output with a delay. The other operation is the same as in FIG. 6. The phases of the pulse signals P3 and P5 may be independent of the phases of the pulse signals P2 and P4 as in FIG. 7, or the phases may be matched as in FIG. 6.

In this configuration, each of the sampling circuits connected in parallel samples a different color signal, thereby reducing a difference in the voltage of the color signal which is sampled and held in the capacitor of each sampling circuit. The voltage required for sampling and holding in the capacitor in the sampling operation thus decreases. This reduces the load to the buffer amplifier in the previous stage of the sampling circuit and lowers the power consumption in the CDS circuit. For example, in the case where color signals of different colors are output alternatively in one line from the imaging device, sampling the color signals of the same color in one sampling circuit allows reduction of the power consumed for the processing of the signals in one line. It is particularly effective in the part where the spatial frequency of the imaging object is low since a difference in the signal level of the same color signals is small.

This embodiment enables the use of a buffer amplifier with a low drive capacity. Further, a settling error decreases as long as the drive capacity of the buffer amplifier is not changed, thus allowing highly accurate signal detection.

### Second Embodiment

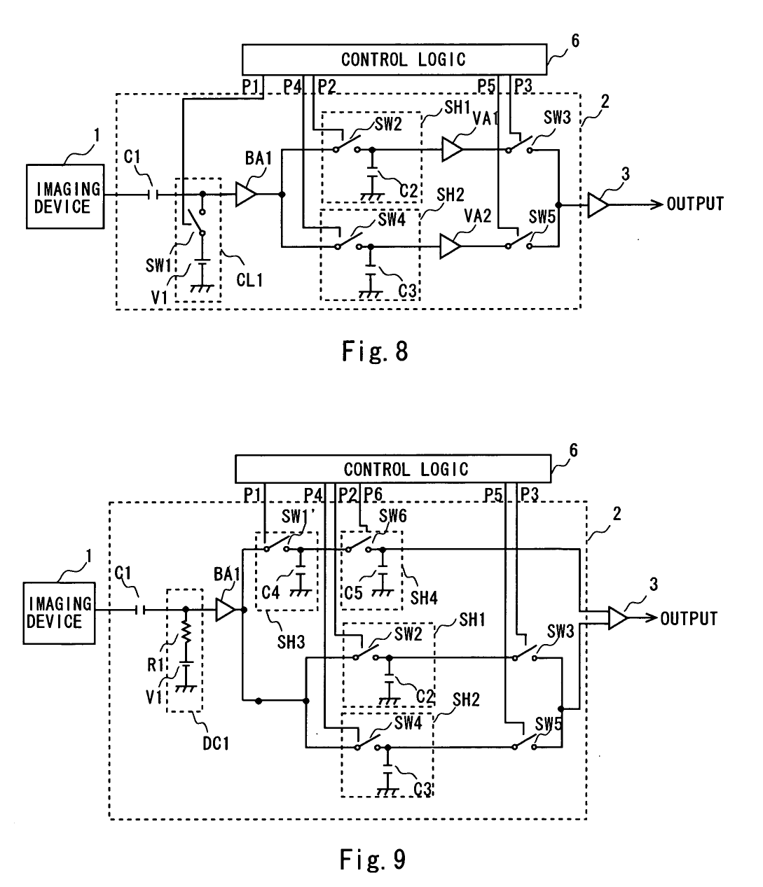

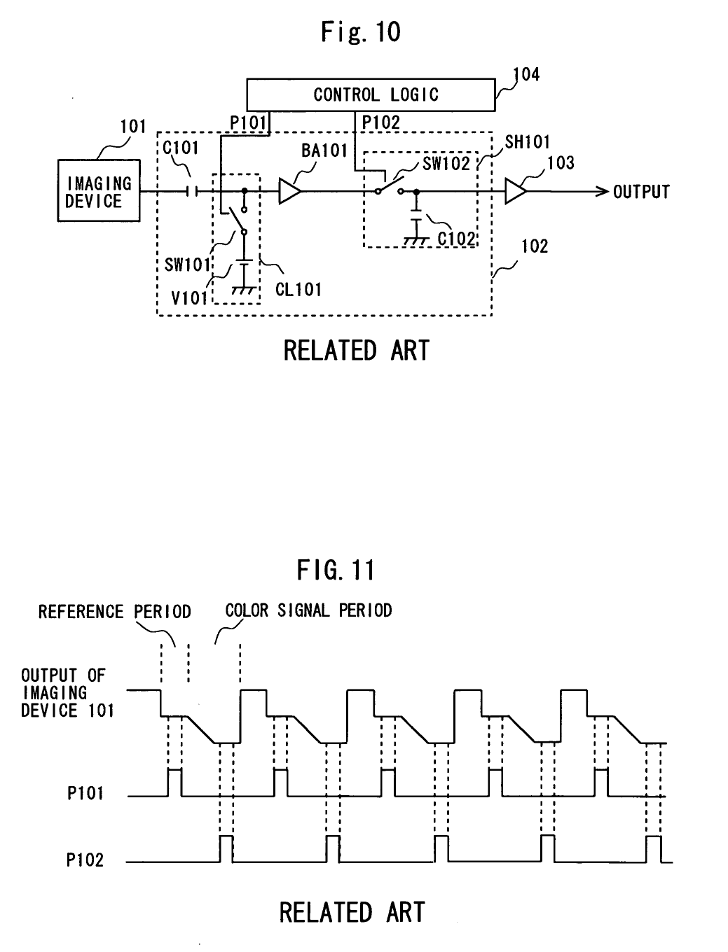

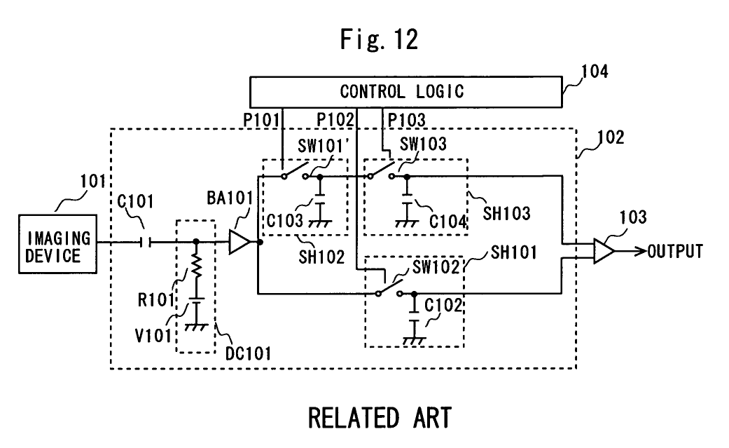

Referring now to the circuit diagram of FIG. 8, the configuration of a CDS circuit of a second embodiment of the invention is explained. The CDS circuit 2 of this embodiment has an amplifier VA1 (first color correction circuit) between the sampling circuit SH1 and the output switch SW3, and an amplifier VA2 (second color correction circuit) between the sampling circuit SH2 and the output switch SW5, in addition to the elements shown in FIG. 3.

The amplifiers VA1 and VA2 may be variable gain amplifiers, for example. The gain of the amplifiers may be varied for each color signal to perform color correction such as white balance.

The variable gain amplifier of FIG. 5 may be used for the amplifiers VA1 and VA2. In this case, since a different amplifiers are used for a different color signal, the frequency of changing the gain for color correction and so on decreases, which reduces switching noise that can occur at the time of switching to change the gain. For example, if the number of pixels in one line is 300 to 2000, the number of times of switching may be reduced to 1/300 to 1/2000 in one line. Further, this embodiment can simplify the circuit configuration since it eliminates the need for placing a circuit for color correction such as white balance or a circuit for noise removal in the next stage of the CDS circuit.

### Third Embodiment

Referring then to the circuit diagram of FIG. 9, the configuration of a CDS circuit of a third embodiment of the invention is explained. In FIG. 9, the same reference symbols as in FIG. 3 designate the same elements.

The CDS circuit 2 of this embodiment includes a capacitor C1, a DC regeneration circuit DC1, a buffer amplifier BA1, sampling circuits SH1 and SH2, a sampling circuit SH3 (third sampling circuit), and a sampling circuit SH4 (third timing regulator or fourth sampling circuit). The capacitor C1 receives the output signal from the imaging device 1. The DC regeneration circuit DC1 regenerates a direct-current component. The buffer amplifier BA1 amplifies the DC-regenerated signal. The sampling circuits SH1 and SH2 sample the signal in the color signal period. The sampling circuit SH3 samples the signal in the reference period. The sampling circuit SH4 matches the phases of the sampling signals in the reference period by regulating signal output timing. The variable gain amplifier 3 clamps the sampling signal in the color signal period to the voltage of the sampling signal in the reference signal as a reference voltage. The clamped signal is input to the A/D converter 4.

The DC regeneration circuit DC1 includes a voltage source V1 and a resistor R1. The voltage source V1 generates a given voltage, with one end grounded. The resistor R1 connects the voltage source V1 to the capacitor C1 and the input end of the buffer amplifier BA1.

The sampling circuits SH3 and SH4 have the same configuration as the sampling circuits SH1 and SH2. The sampling circuits SH3 and SH4 include sampling switches SW1′ and SW6, and capacitors C4 and CS, respectively.

The sampling switches SW1′ and SW6 are turned on or off according to pulse signals P1 and P6, respectively, which are applied from the control logic 6.

The CDS circuit 2 operates in accordance with the same timing chart as the timing charts of FIGS. 6 and 7. Further, the pulse signal P6 is applied in the same timing as the pulse signal P3 or P5 so as to match the phases of the output signals from the sampling circuit SH4 and the sampling circuit SH1 or SH2.

This embodiment allows reduction of power consumption in the CDS circuit just like the circuit shown in FIG. 3. Further, an amplifier may be placed between the sampling circuit and the output switch just like the circuit of FIG. 8.

The configuration of the CDS circuit is not limited to the above examples. For example, the CDS circuit may have a plurality of sampling circuits.

It is apparent that the present invention is not limited to the above embodiment that may be modified and changed without departing from the scope and spirit of the invention.

1. A correlated double sampling circuit comprising:
a plurality of sampling circuits, each sampling each of a plurality of color signals sequentially output from a solid-state imaging device.

2. The correlated double sampling circuit of claim 1, wherein each of the plurality of sampling circuits samples each color of the plurality of color signals.

3. The correlated double sampling circuit of claim 2, further comprising:
a plurality of color correction circuits, each color-correcting a signal sampled by the plurality of sampling circuits.

4. The correlated double sampling circuit of claim 3, wherein each of the color correction circuits is a variable gain amplifier.

5. A signal processing circuit comprising:
an amplifier amplifying a first color signal and a second color signal sequentially output from a solid-state imaging device;
a first sampling circuit sampling the amplified first color signal;
a second sampling circuit sampling the amplified second color signal;
a first timing regulator adjusting an output timing of the signal sampled by the first sampling circuit; and
a second timing regulator adjusting an output timing of the signal sampled by the second sampling circuit.

6. The signal processing circuit of claim 5, wherein the first color signal and the second color signal are color signals of different colors.

7. The signal processing circuit of claim 5, further comprising:
a clamping circuit clamping the first and second color signals to a given voltage, wherein the amplifier amplifies the clamped first and second color signals.

8. The signal processing circuit of claim 5, further comprising:
a third sampling signal sampling a reference signal output from the solid-state imaging device; and
a third timing regulator adjusting an output timing of the signal sampled by the third sampling circuit.

9. The signal processing circuit of claim 5, further comprising:
a first color correction circuit color-correcting the signal sampled by the first sampling circuit; and
a second color correction circuit color-correcting the signal sampled by the second sampling circuit.

10. The signal processing circuit of claim 9, wherein the first color correction circuit and the second color correction circuit are variable gain amplifiers.

11. The signal processing circuit of claim 9, further comprising:
a clamping circuit clamping the first and second color signals to a given voltage, wherein the amplifier amplifies the clamped first and second color signals.

12. The signal processing circuit of claim 9, further comprising:
a third sampling circuit sampling a reference signal output from the solid-state imaging device; and
a third timing regulator adjusting an output timing of the signal sampled by the third sampling circuit.

13. A solid-state imaging apparatus comprising:
a solid-state imaging device sequentially outputting a plurality of color signals;
a first sampling circuit sampling a first color signal selected from the plurality of color signals;
a second sampling circuit sampling a second color signal selected from the plurality of color signals;
a first switching circuit outputting the signal sampled by the first sampling circuit;
a second switching circuit outputting the signal sampled by the second sampling circuit; and
an amplifier amplifying the signal output from the first switching circuit or the second switching circuit.

14. The solid-state imaging apparatus of claim 13, wherein the first color signal and the second color signal are color signals of different colors.

15. The solid-state imaging apparatus of claim 13, wherein the second color signal is a color signal output next to the first color signal from the solid-state imaging device.

16. The solid-state imaging apparatus of claim 13, further comprising:
a clamping circuit clamping the first and second color signals to a given voltage according to a reference signal which is output from the solid-state imaging device together with the first and second color signals.

17. The solid-state imaging apparatus of claim 13, further comprising:
a third sampling circuit sampling a reference signal which is output from the solid-state imaging device together with the first and second color signals; and
a fourth sampling circuit outputting the signal sampled by the third sampling circuit to the amplifier.

18. The solid-state imaging apparatus of claim 13, further comprising:
a first variable gain amplifier amplifying the signal sampled by the first sampling circuit; and
a second variable gain amplifier amplifying the signal sampled by the second sampling circuit.

19. The solid-state imaging apparatus of claim 18, further comprising:
a clamping circuit clamping the first and second color signals to a given voltage according to a reference signal, which is output from the solid-state imaging device together with the first and second color signals.

20. The solid-state imaging apparatus of claim 18, further comprising:
a third sampling circuit sampling a reference signal, which is output from the solid-state imaging device together with the first and second color signals; and
a fourth sampling circuit outputting the signal sampled by the third sampling circuit to the amplifier.
